(19) United States
(12) Patent Application Publication
(10) Pub. No.: US 2004/0047254 A1
(43) Pub. Date: Mar. 11, 2004

(54) Disc drive for adaptively controlling recording speed and method for the same

(75) Inventor: Sung-Ro Go, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/648,329

(22) Filed: Aug. 27, 2003

(30) Foreign Application Priority Data
Sep. 7, 2002 (KR) 2002-54207

(51) Int. Cl. G11B 7/00

(52) U.S. Cl. 369/47.46

(57) ABSTRACT

A method and apparatus for correcting a tilt without repeatedly calculating a tilt angle with respect to a corresponding recording or reproducing sector, by managing the tilt angle detected with respect to each recording sector of a disc in a disc drive. If a tilt of a disc mounted in the disc drive is detected, a memory is searched for a tilt angle for a sector of the disc in which the tilt is detected. If no tilt angle is found in the memory, a tilt angle is calculated for the sector based on the detected tilt of the disc, the tilt of the disc is corrected, and the calculated tilt angle stored in the memory to be used for the sector. If a tilt angle is found in the memory, the tilt of the sector is corrected using the found tilt angle.

### CROSS-REFERENCE TO RELATED APPLICATION

This application claims the benefit of Korean Patent Application No. 2002-54027, filed on Sep. 7, 2002, in the Korean Intellectual Property Office, the disclosure of which is incorporated herein by reference.

### BACKGROUND OF THE INVENTION

1. Field of the Invention

The present invention relates to a disc drive for adaptively controlling a recording speed, and more particularly to, a disc drive for adaptively controlling a recording speed according to a transmission speed of a received signal and a method for the same.

2. Description of the Related Art

A disc drive records data on a disc or reproduces data from the disc. When a received signal is recorded, a conventional disc drive records the received signal on the disc at a predetermined speed regardless of a transmission speed of the received signal. However, a transmission speed of a signal outputted from a channel receiver such as a set top box is not constant. This is because the transmission speed of data can be varied by an information provider or a program which is provided to the set top box.

Thus, the transmission speed of the signal outputted from the channel receiver may be different from the recording speed of the disc drive. If so, the disc drive cannot normally record the signal outputted from the channel receiver.

In the conventional art, a medium is additionally connected between the channel receiver and the disc drive so as to record the signal outputted from the channel receiver on the disc loaded in the disc drive. The medium interfaces the transmission speed of the signal outputted from the channel receiver with the recording speed of the disc drive. A personal computer or a high capacity memory such as a hard disk may be used as the medium.

In the conventional art, since the medium must be additionally connected between the channel receiver and the disc drive, an environment setting task becomes complicated. In addition, a transmission error such as a buffer underrun can occur because the signal outputted from the channel receiver is stored in the medium and then is transmitted to the disc drive. If the transmission error such as the buffer underrun occurs, data transmitted to the disc drive may be damaged.

### SUMMARY OF THE INVENTION

Accordingly, it is an aspect of the present invention to provide a disc drive which controls a recording speed to adapt to a transmission speed of a signal outputted from a channel receiver and a method for the same

It is another aspect of the present invention to provide a disc drive which controls a recording speed, thereby normally recording a signal outputted from a channel receiver on a disc without an additional medium between the channel receiver and the disc drive, and a method for the same.

It is another aspect of the present invention to provide a disc drive which controls a recording speed while controlling a rotation speed of a spindle motor to adapt to a transmission speed of received data and a method for the same.

According to another aspect of the present invention, there is provided a disc drive, which records data on a disc, comprising a clock generator which generates a clock signal that is synchronized with a transmission speed of a received signal, a pickup unit which records recording data corresponding to the received signal on the disc, and a recording processing unit which converts the received signal into recording data by synchronizing with a clock signal generated from the clock generator into recording data and provides the converted recording data to the pickup unit.

According to an aspect of the present invention, the disc drive further comprises a decoder which detects an identifying signal that can be used to identify the transmission speed of the received signal, provides the detected identifying signal to the clock generator, and transmits the received signal to the recording processing unit The clock generator generates the clock signal that is synchronized with the identifying signal. The identifying signal can be a periodic signal.

According to an aspect of the present invention, it, the recording processing unit comprises an encoder which encodes the received signal. The clock generator comprises a phase locked loop circuit. The disc drive includes a spindle motor which rotates the disc, and a spindle motor driving unit which controls a rotation speed of the spindle motor by using the clock signal generated from the clock generator.

According to another aspect of the present invention, there is provided a disc drive which records data on a disc comprising a pickup unit which records recording data corresponding to a received signal on the disc, and a recording processing unit which converts the received signal into recording data by synchronizing with a transmission speed of the received signal and provides the recording data to the pickup unit. The disc drive further comprises a decoder, which detects an identifying signal that can be used to determine the transmission speed of the received signal and transmits the identifying signal to the recording processing unit.

According to yet another aspect of the present invention, there is provided a method of controlling a recording speed of a disc drive capable of recording data on a disc comprising generating a clock signal that is synchronized with a transmission speed of a received signal, converting the received signal into recording data that is to be recorded on the disc by synchronizing with the clock signal, and recording the converted recording data on the disc.

Generating the clock signal includes detecting an identifying signal capable of recognizing the transmission speed of the received signal, and generating a clock signal that is synchronized with the identifying signal. The method further comprises controlling a rotation speed of the spindle motor that rotates the disc by synchronizing with the clock signal.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings in which:

FIG. 1 is a block diagram of a disc drive which adaptively controls a recording speed according to an embodiment of the present invention; and

FIG. 2 is a flowchart showing a method of controlling a recording speed of a disc drive according to an embodiment of the present invention.

### DETAILED DESCRIPTION OF THE INVENTION

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

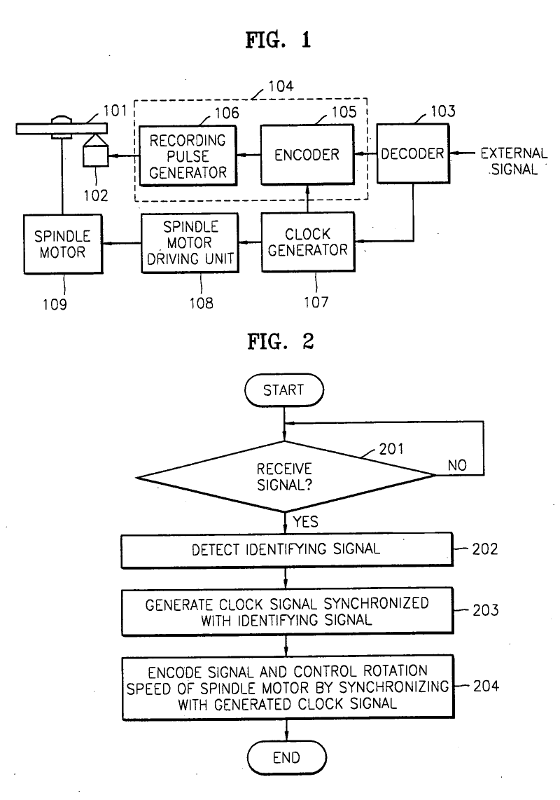

FIG. 1 is a block diagram of a disc drive which adaptively controls a recording speed according to an embodiment of the present invention. Referring to FIG. 1, a disc drive according to the present invention includes a disc 101, a pickup unit 102, a decoder 103, a recording processing unit 104, a clock generator 107, a spindle motor driving unit 108, and a spindle motor 109. The recording processing unit 104 includes a recording pulse generator 106 and an encoder 105.

The disc 101 is a medium such as CD or DVD, in which data can be recorded.

The pickup unit 102 picks up data recorded from the disc 101 by using a laser diode (not shown) and outputs a radio frequency signal that is converted into an electrical signal emitted as light to record data on the disc 101.

The decoder 103 decodes a received signal. The received signal is provided by a channel receiver such as a set top box or the like. The decoder 103 detects an identifying signal from received signals. The identifying signal, as a periodic signal, indicates a transmission speed of the received signals. For example, the identifying signal may be a synchronizing signal or any other predetermined signal.

For example, if a synchronizing signal is the identifying signal, the decoder 103 detects the synchronizing signal included in the received signals as the identifying signal. If a periodic signal other than the synchronizing signal is the identifying signal, the decoder 103 detects the periodic signal included in the received signals as the identifying signal. The identifying signal can be determined when a system is manufactured.

The decoder 103 transmits the detected identifying signal to the clock generator 107 and transmits the received signals other than the identifying signal to the recording processing unit 104.

The recording processing unit 104 converts the signal transmitted from the decoder 103 into recording data which can be recognized by the pickup unit 102. Thus, the recording processing unit 104 includes the encoder 105 and the recording pulse generator 106.

The encoder 105 converts the signal transmitted from the decoder 103 into recording data. A conversion method of the encoder 105 can be one of conventional methods. Here, the encoder 105 encodes the data by synchronizing with a clock signal generated from the clock generator 107. Thus, the recording data outputted from the encoder 105 have a period that is synchronized with the clock signal generated from the clock generator 107.

The recording pulse generator 106 generates a recording pulse corresponding to the recording data transmitted from the encoder 105. Then, the generated recording pulse is transmitted to the pickup unit 102. Thus, the pickup unit 102 records data on the disc 101 according to the generated recording pulse that is synchronized with a transmission speed of the received signal.

The clock generator 107 generates a clock signal that is synchronized with the identifying signal transmitted from the decoder 103. The clock signal is used to control a recording speed of the disc drive. The clock generator 107 can be a phase locked loop (PLL) circuit. The clock signal generated from the clock generator 107 is provided to the encoder 105 and the spindle motor driving unit 108.

The spindle motor driving unit 108 controls a rotation speed of the spindle motor 109 by using the clock signal generated from the clock generator 107 as an operation clock signal. The spindle motor 109 is driven by the spindle motor driving unit 109 and rotates the disc 101.

In this example embodiment, the clock generator 107 is outside the encoder 105. However, the clock generator 107 may be included inside the encoder 105. In this case, the encoder 105 generates a clock signal according to the identifying signal received from the decoder 103 and encodes a signal by synchronizing with the generated clock signal received from the decoder 103.

FIG. 2 is a flowchart showing a method of controlling a recording speed of a disc drive according to an embodiment of the present invention.

First, it is determined whether a signal to be recorded on a disc is received from a channel receiver or the like (operation 201).

If it is determined that the signal is received in operation 201, an identifying signal among the received signals is detected (operation 202). The identifying signal to be detected can be a predetermined signal. For example, if a synchronizing signal is predetermined as the identifying signal, the synchronizing signal included in the received signals is detected as the identifying signal in operation 202.

A clock signal that is synchronized with the detected identifying signal is generated (operation 203). A method of generating the clock signal is previously described with reference to the clock signal 107 of FIG. 1.

A received signal which is synchronized with the generated clock signal is encoded and recorded, and a rotation speed of the spindle motor 109 is controlled by using the clock signal.

As described above, the disc drive according to one aspect of the present invention controls a recording speed of data and a rotation speed of a spindle motor to adapt to a transmission speed of received data, thereby normally recording data received from a channel receiver on a disc without connecting an additional medium between the channel receiver and the disc drive. In addition, any additional tasks required to provide the medium are not necessary, and transmission errors such as a buffer underrun can be prevented from occurring.

According to other aspects of the invention, the recording processor 104 or other component is a computer implementing the method shown in FIG. 2 using data encoded on a computer readable medium.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A disc drive which records data on a disc, the disc drive comprising:
a clock generator which generates a clock signal that is synchronized with a transmission speed of a received signal;
a pickup unit which records recording data corresponding to the received signal on the disc; and
a recording processing unit which converts the received signal into the recording data by synchronizing with a clock signal generated from the clock generator into recording data and provides the converted recording data to the pickup unit.

2. The disc drive of claim 1, wherein the disc drive further comprises a decoder which detects an identifying signal indicating a transmission speed of the received signal, provides the detected identifying signal to the clock generator, transmits the received signal to the recording processing unit, and the clock generator generates the clock signal that is synchronized with the identifying signal.

3. The disc drive of claim 2, wherein the identifying signal is a periodic signal.

4. The disc drive of claim 1, wherein the recording processing unit comprises an encoder which encodes the received signal.

5. The disc drive of claim 1, wherein the clock generator comprises a phase locked loop circuit.

6. The disc drive of claim 1, wherein the disc drive further comprises:
a spindle motor which rotates the disc; and
a spindle motor driving unit which controls a rotation speed of the spindle motor by using the clock signal generated from the clock generator.

7. The disc drive of claim 2, wherein the disc drive further comprises:
a spindle motor which rotates the disc; and
a spindle motor driving unit which controls a rotation speed of the spindle motor by using the clock signal generated from the clock generator.

8. The disc drive according to claim 1, wherein the received signal is from a channel receiver without an additional medium between the channel receiver and the disc drive.

9. A disc drive which records data on a disc, the disc drive comprising:
a pickup unit which records recording data corresponding to a received signal on the disc; and
a recording processing unit which converts the received signal into the recording data by synchronizing with a transmission speed of the received signal and provides the recording data to the pickup unit.

10. The disc drive of claim 9, wherein the disc drive further comprises a decoder which detects an identifying signal capable of indicating the transmission speed of the received signal and transmits the identifying signal to the recording processing unit.

11. The disc drive of claim 10, wherein the identifying signal is a periodic signal.

12. The disc drive of claim 10, wherein the disc drive further comprises:
a spindle motor which rotates the disc; and
a spindle motor driving unit which controls a rotation speed of the spindle motor by synchronizing with the identifying signal.

13. The disc drive of claim 11, wherein the disc drive further comprises:
a spindle motor which rotates the disc; and
a spindle motor driving unit which controls a rotation speed of the spindle motor by synchronizing with the identifying signal.

14. The disc drive according to claim 9, wherein the received signal is from a channel receiver without an additional medium between the channel receiver and the disc drive.

15. A method of controlling a recording speed of a disc drive capable of recording data on a disc, comprising:
generating a clock signal that is synchronized with a transmission speed of a received signal;
converting the received signal into recording data that is to be recorded on the disc by synchronizing with the clock signal; and
recording the converted recording data on the disc.

16. The method of claim 15, wherein the generating the clock signal comprises:
detecting an identifying signal capable of indicating the transmission speed of the received signal; and
generating a clock signal that is synchronized with the identifying signal.

17. The method of claim 16, wherein the identifying signal is a periodic signal.

18. The method of claim 15, further comprising:
controlling a rotation speed of the spindle motor that rotates the disc by synchronizing with the clock signal.

19. The method according to claim 15, wherein the received signal is from a channel receiver without an additional medium between the channel receiver and the disc drive.

20. A computer readable medium encoded with processing instructions implementing a method of controlling a recording speed in a disc drive, the method comprising:
generating a clock signal that is synchronized with a transmission speed of a received signal;
converting the received signal into recording data that is to be recorded on the disc by synchronizing with the clock signal; and
recording the converted recording data on the disc.

21. The computer readable medium according to claim 20, wherein the generating the clock signal comprises:
detecting an identifying signal capable of recognizing the transmission speed of the received signal; and
generating a clock signal that is synchronized with the identifying signal.

22. The computer readable medium according to claim 20, wherein said method further comprises:
controlling a rotation speed of the spindle motor that rotates the disc by synchronizing with the clock signal.

23. A method of controlling a speed of a disc drive, comprising:
transmitting an identifying signal of a transmission speed of an other transmitted signal;
receiving the identifying signal and the other transmitted signal; and
generating a clock signal synchronized with the transmission speed of the other transmitted signal.

24. A method of controlling a speed of a disc drive according to claim 23, further comprising:
converting the other transmitted signal into data synchronized with the clock signal.

25. An apparatus for controlling a speed of a disc drive, comprising:
a transmitter to transmit an identifying signal and an other transmitted signal, wherein the identifying signal identifies a transmission speed of the other transmitted signal;
a receiver to receive the identifying signal and the other transmitted signal; and
a generator to generate a clock signal synchronized with the transmission speed of the other transmitted signal,

26. An apparatus for controlling a speed of a disc drive according to claim 25, further including a converter to convert the other transmitted signal into data synchronized with the clock signal.

27. A computer readable medium encoded with processing instructions for implementing a method of controlling a recording speed in a disc drive, the method comprising:
transmitting an identifying signal of a transmission speed of an other transmitted signal;
receiving the identifying signal and the other transmitted signal; and
generating a clock signal synchronized with the transmission speed of the other transmitted signal.

28. The computer readable medium of claim 25, wherein said method further comprises:
converting the other transmitted signal into data synchronized with the clock signal.
